(19) United States
(12) Patent Application Publication
(10) Pub. No.: US 2024/0384173 A1
(43) Pub. Date: Nov. 21, 2024

(54) SYSTEMS AND APPARATUS FOR PYROLYSIS OF END OF LIFE PLASTIC

(71) Applicant: Plastic Energy Limited, London (GB)

(72) Inventors: David McNamara, London (GB); Christopher Strivens, London (GB); Andres Yabrudy, London (GB); Juan Silva Perez, London (GB); Patrick Dunphy, London (GB)

(21) Appl. No.: 18/682,320

(22) PCT Filed: Aug. 9, 2022
(86) PCT No.: PCT/GB2022/052068

§ 371 Date: Feb. 8, 2024

(30) Foreign Application Priority Data
Aug. 9, 2021 (GB) 2111460.8

(51) Int. Cl. C10B 47/18; C10B 53/07; C10G 1/10

(52) U.S. Cl. CPC C10B 47/18; C10B 53/07; C10G 1/10; C10G 2300/1003

(57) ABSTRACT

The present invention relates to the processing of waste plastics (end-of-life plastic) to obtain hydrocarbons for the production of fuel or further plastics. A method of controlling a process for pyrolysis, comprising: charging a reactor vessel with plastic material: processing the plastics material by: heating the reactor vessel to pyrolyse the plastics material: driving an agitator within the reactor vessel to mix the material in the reactor vessel: and receiving hydrocarbon vapour from the reactor vessel: monitoring one or more parameter(s) consisting of: the agitator load: and/or a plurality of temperatures at a plurality of different heights within the reactor vessel: and/or the temperature of vapour received from the reactor vessel: and in response to the monitored parameter(s): modifying the heating and/or driving: and/or concluding the processing.

### FIELD OF THE INVENTION

The present invention relates to the processing of waste plastics (end-of-life plastic) to obtain hydrocarbons for the production of fuel or further plastics.

### BACKGROUND ART

End of life plastic chemical recycling technology is generally designed to recycle mixed waste-plastics into a variety of liquid hydrocarbon products. These waste plastics are converted into the liquid hydrocarbon products by supplying the plastic feed in molten form into reactor vessels. The reactor vessels are externally heated by combustion systems to a temperature in excess of 350°° C. This produces rich saturated hydrocarbon vapour from the molten plastic, which flows out of the reactor vessels through contactor vessels with the heavier vapour fractions condensing. This is then distilled at near-atmospheric pressures in a downstream atmospheric distillation column.

Systems for pyrolysis of end-of-life plastics are known, such as in WO2011077419A1, and WO2016030460A1, and WO2020065316A1.

Since the systems are supplied with material in the form of mixed waste end-of-life plastics, the exact composition of the source material is very unpredictable. It may be sourced from any recycled plastic with varying properties and varying impurities, from plastic bottles to plastic bags. The waste plastics for use in such a process may, for example, include low density polyethylene (LDPE), high density polyethylene (HDPE), polystyrene (PS), and/or polypropylene (PP). The quantities of each of the various types of plastic are not known at the start of processing. As a result, it is difficult to predict an accurate processing time for the plastics material, since this is highly dependent upon the material and can also depend on feed rates and batch size.

There is a continual need to improve efficiency in such pyrolysis systems, not merely with respect to the effectiveness of extracting hydrocarbons from the plastic material being processed, but also with respect to the energy efficiency of the entire process. This improvement in efficiency must be achieved in the context of the unpredictable feed of waste plastic.

### SUMMARY

Accordingly, the following presents a method of controlling a process for pyrolysis and a pyrolysis system. Such method and system are preferably arranged for batch or semi-batch processing of plastics material, as discussed below.

### LIST OF FIGURES

For a better understanding of the invention, and to show how the same may be put into effect, reference is now made, by way of example only, to the accompanying drawings in which:

FIG. 1 shows a reactor assembly for processing plastics material;

FIG. 2 shows an example of the variation of power required to drive the agitator over time;

FIG. 3 shows an example of the variation of temperature distribution in the reactor vessel over time;

FIG. 4 shows a schematic representation of the reactor system;

FIG. 5 shows a schematic representation of a mixing vessel; and

FIG. 6 shows a schematic representation of a dewatering container.

### OVERALL STRUCTURE

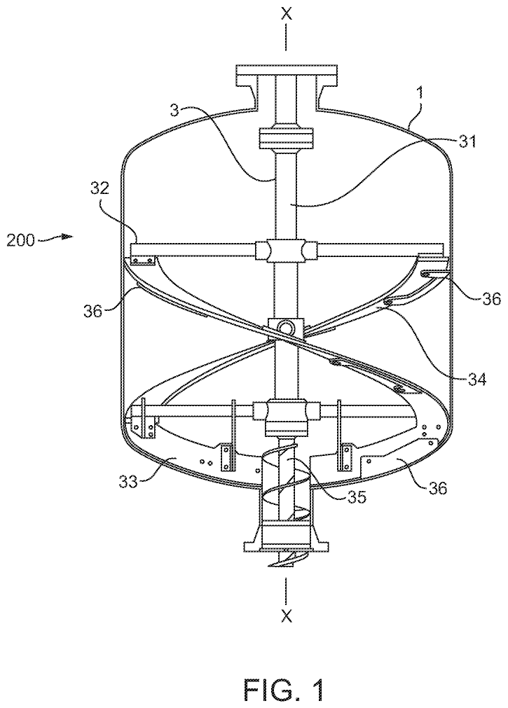

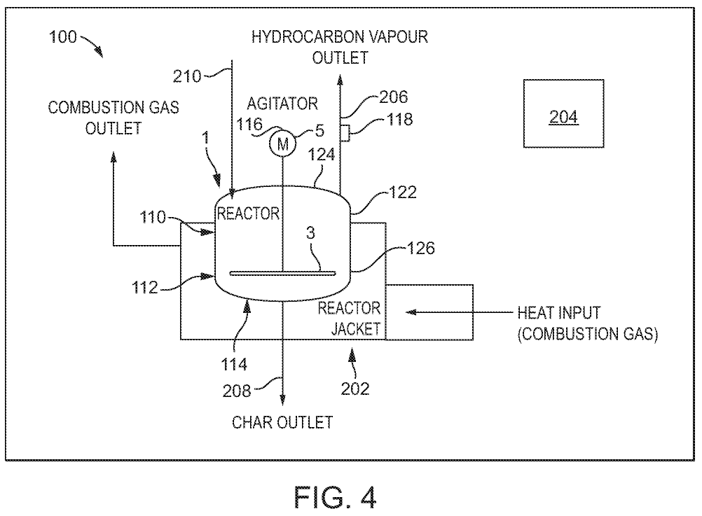

FIG. 4 depicts a reactor system 100 for the pyrolysis of plastics material. The reactor system 100 includes a reactor vessel 1, such as that described with reference to FIG. 1.

The reactor system 100 comprises: a reactor vessel 1; an actuator 5; an agitator 3; a supply inlet 210; a vapour outlet 206; a char outlet 208; a heater 202; a sensor system 110, 112, 114, 116, 118; and a controller 204.

The reactor vessel 1 has a supply inlet 210 for receiving a feed of plastics material.

The reactor vessel 1 has a vapour outlet 206 for egress of hydrocarbon vapour.

The reactor vessel 1 has a char outlet 208 for dispensing char.

The agitator 3 is for mixing material within the reactor vessel 1. Preferably, the agitator is that described with reference to FIG. 1.

The agitator 3 is driven by the actuator 5. Preferably, the actuator 5 is a motor or engine (preferably a motor), which drives the agitator 3 to rotate within the reactor vessel 1. Preferably, the actuator 5 is reversible.

The heater 202 is arranged for heating the contents of the reactor vessel 1. Preferably, the heater 202 is a jacket that surrounds some or all of the reactor vessel 1 for transferring heat from a heating fluid to the contents of the reactor vessel 1. The jacket may receive a flow of heated fluid such as a combustion gas,

The sensor system 110, 112, 114, 116, 118 monitors various operating parameters of the process and reactor system 100.

The sensor system 110, 112, 114, 116, 118 includes a vapour temperature sensor 118 downstream of the vapour outlet 206 for producing a signal indicative of the temperature of the vapour leaving the reactor vessel 1.

The sensor system 110, 112, 114, 116, 118 includes an actuator sensor 116 for producing a signal indicative of an operating parameter of the actuator 5. The operating parameter may be representative of the load on the agitator 3.

The sensor system 110, 112, 114, 116, 118 includes a plurality of temperature sensors 110, 112, 114 respectively located at a plurality of locations on the reactor vessel 1, each for producing a signal indicative of temperature. The temperature sensors are preferably on the outer surface of the wall of the reactor vessel 1.

The controller 204 monitors the process as it progresses within the reactor system 100 and controls the reactor system 100.

The controller 204 monitors the signals received from the sensor system 110, 112, 114, 116, 118.

The controller 204 controls the amount of heat provided by the heater to the reactor vessel 1 and the speed and/or power supplied to the actuator 5.

The reactor system 100 may also comprises a char discharger (for actively discharging charge, rather than simply relying upon gravity). In preferred embodiments, this may comprise the agitator 3 and/or a central shaft auger 35 (possibly, formed integrally with the agitator 3) as discussed with reference to FIG. 1. In such cases, the agitator 3 may be drivable in reverse such that downward force is applied through the char outlet 208 of the reactor vessel 1 to discharge char from the reactor vessel 1. “Reverse” in this context means opposite to the normal driving direction in which the agitator 3 is driven during processing, which is arranged to lift the contents of the reactor vessel 1 and so promote mixing.

### Reactor Vessel

The process of pyrolysis may be carried out within a reactor vessel 1, such as that shown in FIG. 1, which provides a non-limiting example of a suitable reactor vessel.

In the reactor vessel 1 an agitator 3 may be rotatably mounted. The agitator 3 may include a central shaft 31 which generally extends longitudinally in the reactor vessel 1. The agitator 3 is mounted such that it is rotatable about an axis X. The axis X is preferably generally coincident with the central shaft 31 and centre-axis of upper and lower openings of the reactor vessel 1. A plurality of horizontal support bars 32 may extend from the central shaft 31 of the agitator 3. Attached to the horizontal bars 32 are a plurality of agitator blades 34. In alternative embodiments, other configurations of agitator 3 may be used. It is merely required that the agitator 3 is arranged to mix material within the reactor vessel 1.

The agitator 3 is installed within the reactor vessel in order to improve a number of functions of the system. In particular, the agitator 3 may increase the thermal homogenisation of the molten plastic mixture. This may reduce the reaction time by maximising the heat transfer from reactor vessel skin and preventing cold spots from forming. This thermal homogenisation may further prevent vapour bubbles from forming within the plastic mass of more volatile hydrocarbon chains. This may then reduce the risk of subsequent pressure and/or temperature spikes. The agitator 3 may remove problematic by-products (material known as “char”) which lead to coking forming on the inner surface of the reactor vessel wall. An excess build-up of char may inhibit thermal conduction from the reactor wall to the molten plastic. The agitator 3 may also help char drying by continuously mixing it and bringing it into contact with hotter portions of the reactor vessel, such as the vessel skin. Finally, the agitator 3 may improve char by-product removal by forcing the char from the reactor vessel.

While the present embodiment includes a plurality of agitator blades 34 it is anticipated that the agitator 3 may be designed in any suitable manner. In particular, the agitator 3 may include one agitator blade 34 or three or more agitator blades 34 in alternative embodiments. The agitator blades 34 are generally helical such that they are distally spaced from the central shaft 31 by generally constant distance. As such, the outer edge of the agitator blades 34 are generally spaced a constant distance from an inner surface of the reactor vessel 1. The agitator blades 34 may comprise at their lower end (either as a separate part or integral therewith) an agitator base portion 33. The base portion 33 generally conforms to a lower curved surface of the reactor vessel 1. The base portion 33 may be a separate component which is attached to a main portion of the agitator blades 34, or the base portion 33 may be integrally formed therewith.

The agitator 3 may further comprise a central shaft auger 35. This allows the agitator 3 to be further operated in a “reverse” mode in which downward force is applied through the discharge nozzle of the reactor vessel 1 into a char hopper vessel by the central shaft auger 35. This allows char to be expelled from the reaction vessel 1.

In other embodiments, the auger 35 may be provided separately from the agitator 3, and act alone as a char discharger.

Auger 35 may be located within the char outlet 208. When driven to rotate in one direction, the auger 35 can force char from the reactor vessel 1 through the char outlet 35.

In use, plastic is fed into the reactor vessel 1, preferably in the form of extruded melted plastic. The agitator 3 is driven, for example, to rotate about axis X. The agitator blades 34 then rotate in the plastic and can mix this plastic throughout the reactor vessel 1.

Although not essential, the reactor system 100 is preferably used in a semi-batch process. A “semi-batch process” means that processing of the plastics material may begin while plastics material is still being fed into the reactor vessel 1, but that the feeding of plastic material stops at a predetermined total charge and does not continue throughout processing as it would in a “continuous” process. The hydrocarbon yield available per batch will depending on the exact make-up of the plastic fed into the reactor vessel 1. However, the time required to dry the char by-product results in negligible hydrocarbon production. The rate at which hydrocarbons are produced reduces towards the end of the process such that the efficiency of the process decreases.

As the reactor system 100 is operated, hydrocarbon vapour is evacuated from the reactor vessel 1 and the make-up of the reactor contents left within the reactor vessel 1 changes. The reactor contents comprises a mixture of hydrocarbons and char. As the process continues, the shorter chain hydrocarbons form vapour, leaving a residue of a wax, formed (predominantly) of the longer chain hydrocarbons, that is mixed with the char. That is, the reactor contents includes not yet evacuated hydrocarbon vapour and the residue. As the hydrocarbon yield increases, the wax content of the residue reduces. This changes the viscosity of the residue.

Towards the end of the process, the wax content of the residue reduces and it forms a solid that can be said to be drying. Typically, at this point in the process, the ratio of wax to char content of the residue will be in the region of 5% to 12% by mass.

Whereas it would seem preferable to maximise the yield of hydrocarbons, counter-intuitively, the inventors have recognised that by deliberately not extracting the maximum yield of hydrocarbons, other advantages may result. Firstly, not maximising yield can significantly reduce processing time. In one example, the last 15% to 20% of processing time produced only 5% of the total yield. Secondly, not maximising the yield can improve the overall energy efficiency of the system, since the end of the process produces less hydrocarbon vapour yield per unit energy expended.

Through extensive experimentation, the inventors have identified that a by-product residue having a wax to char ratio of 2% to 20% by mass, and preferably 5% to 12% by mass is particularly beneficial for downstream handling of the residue and provides an efficient process.

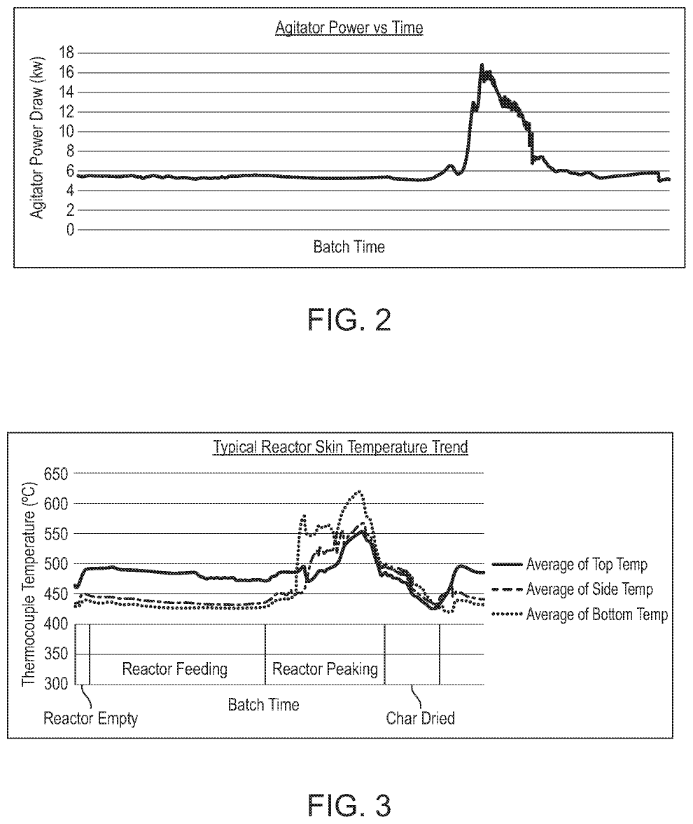

The inventors have realised that the progress of the process and so the wax to char ratio may best be established by reference to the timing of agitator peak power draw depicted in FIG. 2 and/or the temperature differentials depicted in FIG. 3. These monitoring concepts are discussed below.

The ability to monitor a parameter indirectly indicative of the wax content of the residue enables the wax content to be controlled within bounds that enable particular apparatus for processing the discharged by-product residue.

In particular, this enables a preferred method of quenching the by-product residue via direct contact with a liquid such as water. Although it would be possible, without the ability to accurately control the wax content of the residue, the use of liquid for quenching is more difficult, since the agglomeration of the wasted reactor contents may be too great to form an easily manageable slurry or too low for the slurry to be appropriately dewatered.

An embodiment of a method for pyrolysis comprises the following steps: charging a reactor vessel with plastics material; heating the reactor vessel to pyrolyse the plastics material (optionally, the heating step may overlap with the charging step); driving an agitator within the reactor vessel to mix the reactor contents in the reactor vessel; receiving hydrocarbon vapour from the reactor vessel; and discharging the residue formed from the remaining reactor contents.

Preferably, the residue is discharged when it has a wax content of between 2% to 20% by mass, and preferably 5% to 12% by mass.

The amount of wax in the residue cannot be directly measured. Moreover, the wax content cannot be estimated accurately based solely upon the amount of time the process has been running, since the make up of the feed material, the feed rates and the exact batch size is unknown.

### Agitator Load

FIG. 2 shows the variation of power required to drive the agitator over time. Although the use of agitator load to indicate that char drying is taking place has been noted, there has not to-date been any use of this information to modify the operating parameters of the system.

The agitator load may be determined, for example, based on the power, current or voltage used by an actuator, such as a motor, driving the agitator 3, or by a torque of force applied to the agitator 3 by an actuator 5 (a motor or an engine, etc.). Any such signal indicative of agitator load is suitable for providing an indication of viscosity of the residue. Power drawn by the actuator 5 has been found to provide a convenient reliable signal.

The inventors have realised that the agitator load, because of its relationship to the viscosity and the amount of the residue, can be used to provide an indirect indication of wax content, which in turn can be used as an indirect indication of the ease of future processing of the discharged by-product residue (the remaining reactor contents and the end of processing).

As mentioned above, the reactor contents varies throughout the process as hydrocarbon vapour is obtained from the reactor vessel 1, such that the wax content of the residue reduces.

At an early stage, once liquid, the reactor contents are of the lowest viscosity, with a low char to liquid ratio. During this phase, the resistance of the reactor contents to the motion of the agitator is low. Over time, the reactor contents increases in viscosity until, eventually, the highest viscosity is reached. Shortly before this point, the resistance of the reactor contents to the motion of the agitator 3 increases sharply thereby increasing the agitator load on the actuator 5.

Following this point, the wax content of the residue reduces further and it forms a solid that can be said to be drying.

It has not previously been recognised that the agitator load can provide a reliable enough indicator of the state of the process within the reactor vessel 1 that control parameters may be modified in dependence upon this signal.

For example, in some cases, it may be preferred to speed up the rate of drying of the residue towards the end of processing so that it may be discharged sooner. This may slightly reduce the hydrocarbon yield from a particular batch of source plastics material, but can significantly reduce the time and energy cost of processing each batch. Therefore, the controller may be programmed to alter the operating mode from a pyrolysis mode to a char drying mode in order to speed up the drying of the char (i.e., the removal of hydrocarbons from the residue). In the char drying mode, the heat supplied by the heating jacket may be increased as compared with the pyrolysis mode. Alternative, or in addition, in the char drying mode, the driving speed of the agitator 3 may be increased as compared with the pyrolysis mode.

In other cases, the agitator load signal may be used to initiate the discharge of the residue.

### Stall Protection

In addition, the inventors have realised that the monitoring of the agitator load signal can provide an early warning that may be used to prevent stalling of the actuator 5 such as a drive motor of the agitator 3.

A problem has been recognised that if the viscosity of the reactor contents increases too far, then the agitator 3 may stall. If the agitator 3 stalls, then it is often not possible to start it moving again.

In such cases, an onerous manual procedure is required. Firstly, the reactor system 100 must be shut down. Then the reactor vessel 1 must be cooled. The residue within the reactor vessel 1 must then be manually removed. This can be very time consuming and impacts the rate of production of the overall process.

By monitoring the agitator load signal, the controller 204 can predict when the viscosity of the residue will exceed a threshold that is expected to stall the agitator, and change the operating parameters to prevent the stall.

For example, the controller may compare the agitator load with a stall-avoidance threshold that is a predetermined fraction of a stalling load.

In response to a determination that a stall is imminent, the controller may reduce the speed of the agitator 3 from its normal set point, for example, the rate of rotation. In this way, a stall may be avoided.

More preferably, in some embodiments, a control system may be provided for adjusting the speed of the agitator 3 such that the agitator load is equal to the predetermined fraction of the stalling load. This control system may be triggered in response to the determination that a stall is imminent.

In this way, as the viscosity of the of the reactor contents reduces from the peak value, the agitator 3 can increase in speed until it returns to the normal set point, once the agitator load has dropped sufficiently.

### Reactor Temperature Measurement

In a preferred embodiment, a plurality of temperature sensors 110, 112, 114 are provided for producing a signal indicative of the temperature of the reactor contents adjacent the temperature sensor 110, 112, 114. The temperature sensors are provided at a plurality of locations on the reactor vessel 1, at different heights.

The plurality of temperature sensors 110, 112, 114 may, for example, be mounted on the external skin of the reactor vessel 1 at different heights within the area of the heating jacket. Since the heating jacket evenly heats the outer surface of the reactor vessel 1, any temperature difference between the sensors 110, 112, 114 will be the result of the temperature of the reactor contents adjacent the temperature sensor 110, 112, 114.

A first temperature sensor 110 is preferably provided within the upper 50% of the height of the reactor vessel 1. A second temperature sensor 112 is preferably provided within the lower 20% to 50% of the height of the reactor vessel 1. A third temperature sensor 114 is preferably provided within the lower 20% of the height of the reactor vessel 1.

For example, the reactor vessel 1 may be shaped with a generally cylindrical wall 122 enclosed by a top surface 124 and a bottom surface 126. The first sensor 110 may be provided on the generally cylindrical wall 122 at a first height. The second sensor 112 may be provided on the generally cylindrical wall 122 at a second height, lower than the first height. The third temperature sensor 114 may be provided on the bottom surface 126.

The first temperature sensor 110 measures a first temperature, the second temperature sensor 112 measures a second temperature, and the third temperature sensor 114 measures a third temperature.

Since the temperature sensors 110, 112, 114 are all within the area of the heating jacket, when the reactor vessel 1 is empty, prior to charging, the temperature sensors 110, 112, 114 will all register approximately the same temperature.

Accordingly, a first temperature distribution between the temperature sensors 110, 112, 114 is present. The first temperature, the second temperature, and the third temperature are substantially equal.

The reactor vessel 1 is heated prior to charging with plastics material. Once charged with plastics material, this will melt (if not provided in liquid form) until a maximum level of liquid contents is reached. As hydrocarbon vapour is obtained from the reactor vessel 1, the liquid level will lower.

The reactor vessel 1 is charged with plastics material to a level such that the first temperature sensor 110 is above the maximum level of any liquid reactor contents, and the second and third temperature sensors 112, 114 are below the level of any liquid contents.

At an early stage of processing, when the reactor contents is liquid, the second and third temperature sensors 112, 114 will register similar temperatures. The only difference will be a slightly lower temperature of the reactor contents at the bottom of the reactor adjacent the third temperature sensor 114, due to the cooling impact of colder molten feed plastic. However, the temperature registered by the first temperature sensor 110 will be much higher, because there will not be any liquid presence at that elevation within the reactor vessel 1, meaning reduced transfer of heat from the wall due to reduced thermal conductivity.

Accordingly, a second temperature distribution between the temperature sensors 110, 112, 114 is present. The first temperature exceeds the second temperature and the second temperature substantially equals the third temperature.

As processing continues, and hydrocarbon vapour is obtained from the reactor vessel 1, the liquid content decreases whilst the char content increases, reducing the contents level within the reactor vessel 1 and leading to semi-liquid contents, which has reduced thermal conductivity. As a result, the thermal conductivity of the reactor contents adjacent the third temperature sensor 114 decreases so that a higher temperature is registered, while the temperature registered by the second temperature sensor 112 approaches that registered by the first temperature sensor 110, which is slightly lowered. This is because, the heat transfer into the reactor vessel 1 reduces since the liquid level has reduced, and so the entire reactor vessel 1 increases in temperature, but due to the presence of highly insulating material at the bottom of the reactor vessel 1, this section heats more than the upper sections of the reactor vessel 1. Moreover, the presence of vapour within the reactor vessel 1 can exacerbate this differential. As a result, the first and second temperature sensors 110, 112 register lower temperatures than the third temperature sensor 114.

Accordingly, a third temperature distribution between the temperature sensors 110, 112, 114 is present. The first temperature substantially equals the second temperature and the second temperature is less than the third temperature.

Finally, after further processing, the semi-liquid contents becomes solid, drying by-product (char mixed with wax) with limited production of hydrocarbon vapour. This drying by-product has low thermal conductivity, and so no longer takes heat away from the wall of the reactor vessel 1. Thus, the temperature registered by the third temperature sensor 114 increases.

Accordingly, a fourth temperature distribution between the temperature sensors 110, 112, 114 is present. The first temperature, the second temperature, and the third temperature are substantially equal.

The temperature distribution sensed by the plurality of temperature sensors 110, 112, 114 therefore varies in a predictable way over time. The time course of the temperature distribution can reliably indicate the stage of the processing of the reactor contents in a manner robust to the make up of the feed material.

Furthermore, with reference to FIG. 3, there can be seen that the individual temperatures reach a peak at similar times, but that the bottom temperature (that from third temperature sensor 114) peaks by a greater amount than the top (temperature sensor 110) and side (temperature sensor 112) temperatures. The inventors have found that the timing of the peak temperature differential is a useful indicator of the peak viscosity being achieved. The peak temperature differential may be the difference between either the first or the second temperatures and the third temperature (or, optionally, the difference between an average or weighted sum the first and second temperatures and the third temperature).

For example, (i) the difference between the first temperature and the third temperature; (ii) the difference between the second temperature and the third temperature; (iii) the difference between the third temperature and an average of the first and second temperatures; (iv) the difference between the third temperature and a weighted average (to compensate for different heights) of the first and second temperatures; etc.

In general, a peak temperature differential is determined as the difference between temperatures measured at two locations exceeding a temperature differential threshold. For example, the difference between the first temperature and the third temperature exceeding a threshold. Preferably, the threshold is in the range of 50 degrees centigrade to 100 degrees centigrade.

### Vapour Temperature

The vapour temperature sensor 118 is provided to measure the temperature of the vapour leaving the reactor vessel 1 through the vapour outlet 206. The inventors have realised that this temperature also provides useful information regarding the state of the process within the reactor vessel 1.

Specifically, when this temperature falls below a threshold, this can be indicative of the same point in the process as the agitator or temperature differential peaks described above.

A suitable vapour temperature threshold may be, for example, in the range 90 to 110 degree centigrade, such as 100 degrees centigrade.

### Process

A preferred embodiment of a batch process for pyrolysis, comprises: charging a reactor vessel with plastic material; heating the reactor vessel to pyrolyse the plastics material; driving an agitator within the reactor vessel to mix the material in the reactor vessel; receiving hydrocarbon vapour from the reactor vessel; and monitoring one or more parameter(s) of the process or system.

Monitoring one or more parameter(s) may involve monitoring: the agitator 3 load (as described above); and/or a plurality of temperatures at a plurality of heights within the reactor vessel 1 (as described above); and/or the temperature of vapour received from the reactor vessel 1.

The controller 204 controls the batch process. The controller may also modify the heating and/or driving based on the monitored parameter(s) and/or conclude the batch process based on the monitored parameter(s).

Specifically, the controller 204 operates the reactor system 100 in one of a plurality of operating modes.

The controller 204 may be arranged to operate the reactor system 100 in a normal pyrolysis mode in which the actuator 5 drives the agitator 3 at a first speed, and the heater 202 produces a first amount of heat.

The controller 204 may be arranged to operate the reactor system 100 in a trip-avoidance pyrolysis mode in which the actuator 5 drives the agitator 3 at a second speed, and the heater 202 produces a second amount of heat, wherein the second speed is lower than the first speed.

Optionally, the controller 204 may be arranged to operate the reactor system 100 in a char drying mode in which the actuator 5 drives the agitator 2 at a second speed, and the heater 202 produces a second amount of heat, the second amount of heat being greater than the first amount of heat.

The controller 204 may be arranged to operate the reactor system 100 in a char discharging mode in which the residue (including the char and wax mix) is discharged through the char outlet 208.

### Normal Pyrolysis Mode

The controller 204 may implement the normal pyrolysis mode. In this mode, the heater 202 heats the reactor vessel 1 to bring the reactor contents to a temperature of between 390 degrees centigrade and 430 degrees centigrade. The agitator is driven to rotate at 30 and 40 revolutions per minute.

The controller 204 may implement the normal pyrolysis mode, and then switch to another mode based on the monitored parameter(s).

### Trip-Avoidance Pyrolysis Mode

For example, the controller 204 may sense an increase in the agitator load 3 to above a stall-avoidance threshold (as discussed above), and then reduce the speed of the agitator 3 to avoid the stalling of the agitator 3. For example, the agitator 3 may reduce in speed by 65%.

In a preferred embodiment, in the trip-avoidance pyrolysis mode, the speed of the agitator is modulated to prevent the agitator load from exceeding the stall-avoidance threshold.

### Char Drying Mode

In some embodiments, the controller 204 switches to the char drying mode based on the monitored parameter(s). For example, as discussed above, the controller 204 may monitor parameter(s) to estimate the point at which the wax content of the residue is between 2% and 20%, and preferably between 5% and 12% by mass.

One way this may be done is to monitor the timing of the agitator 3 peak load, continuing the normal pyrolysis mode for a fixed period of time following the peak, and then switching to the char drying mode.

Alternatively, the use of the temperature distribution signals may be used to establish when to switch to the char drying mode. This may be either that the peak temperature differential is achieved, or that the tracked progression of temperature differentials has progressed in the manner set out above to the third temperature distribution.

The temperature distribution and the agitator peak load timing may be used in combination by switching to the char drying mode a fixed period after both the agitator peak load and the peak temperature differential have been sensed. That is, a fixed period after the later of the agitator peak load and the peak temperature differential.

In the char drying mode, the controller 204 may control the heater 202 to heat the reactor vessel 1 to bring the reactor contents to a temperature of between 420 degrees centigrade and 430 degrees centigrade, and the actuator 5 to rotate the agitator 3 at between 30 and 40 revolutions per minute. Typically, the char drying mode is implemented for a fixed period of time, before the controller 204 switches operation to the char discharging mode.

### Char Discharging Mode

In some embodiments, the controller 204 concludes the batch process based on the monitored parameter(s). For example, as discussed above, the controller 204 may monitor parameter(s) to estimate the point at which the wax content of the residue is between 2% and 20%, and preferably between 5% and 12% by mass.

One way this may be done is to monitor the timing of the agitator 3 peak load, and continue processing for a fixed period of time following this, and then conclude processing and discharge the by-product residue via the char outlet 208.

Alternatively, this may be done by monitoring the timing of the peak temperature differential, and continue processing for a fixed period of time following this, and then conclude processing and discharge the by-product residue via the char outlet 208.

Alternatively, this may be done by monitoring the time at which the vapour temperature drops below the vapour temperature threshold, and continue processing for a fixed period of time following this, and then conclude processing and discharge the by-product residue via the char outlet 208.

A preferred option is to monitor the timing of both of the agitator peak and the peak temperature differential, and continue processing for a fixed period of time following the determination that both peaks have occurred, and then conclude processing and discharge the by-product residue via the char outlet 208.

However, the vapour temperature dropping below the vapour temperature threshold is a useful sign that can supplement either of the peak determinations.

A most preferred option is therefore to monitor the timing of both of the agitator peak and the peak temperature differential, and also to monitor the vapour temperature, and continue processing for a fixed period of time following the determination that both peaks have occurred and also the determination that the vapour temperature has dropped below the vapour temperature threshold, and then conclude processing and discharge the by-product residue via the char outlet 208.

The process of discharging is preferably an automated (non-manual) process, for example, using auger 35, described above.

### Quenching

At the conclusion of processing, the hot by-product residue must be discharged via the char outlet 208.

A preferred method of by-product management for the discharged by-product residue involves quenching in liquid to produce a slurry. The liquid is preferably water, but may include other solvents. Water is preferred because of its ease of separation from the slurry for re-use, and the fact that it is not as volatile as other solvents.

As indicated above, one benefit of the disclosed methods for monitoring the state of the process is that the residue may be discharged at a time when the residue has a predetermined wax content between 2% and 20%, and preferably between 5% to 12% by mass. Although it is not essential that the wax content is between those limits, they have been found to provide preferred properties of the slurry that results from quenching the residue.

A preferred quenching system comprises a mixing vessel and a dewatering container (that is, a container for removing liquid, whether water or another liquid).

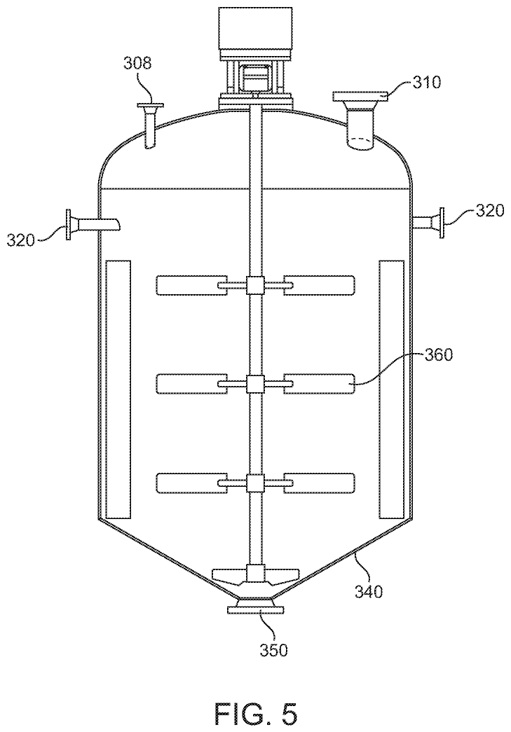

A preferred mixing vessel 300 is shown in FIG. 5. The mixing vessel 300 comprises a char inlet 308, in communication with the char outlet 208, and a slurry outlet 350.

Preferably, the mixing vessel is positioned directly below the reactor vessel 1 such that the char outlet 208 is directly above the char inlet 308.

Preferably, the slurry outlet 350 is at the lower end of a conical lower section 340 of the mixing vessel 300.

The mixing vessel 300 comprises one or more liquid inlets 320. These are preferably arranged tangentially to provide a supply of liquid with rotational momentum.

The mixing vessel 300 may be filled with a predetermined quantity of liquid prior to receiving the by-product residue discharged from the reactor vessel 1. In alternative, but less preferred embodiments, the liquid may be supplied to the mixing vessel 300 after the by-product residue is discharged from the reactor vessel 1 into the mixing vessel 300.

It is preferable to provide the liquid in the mixing vessel 300 first in order to reduce loss of liquid through evaporation.

The temperature of the by-product residue is likely to be at least 35 degrees centigrade and can be as high as 60 degrees centigrade. Accordingly, a significant amount of steam is generated when the by-product residue enters the liquid within the mixing vessel 300. Accordingly, the mixing vessel 300 comprises a steam outlet 310. The steam may also carry some hydrocarbon vapour, and so the steam outlet 310 may be in communication with a downstream steam scrubbing system.

In order to reduce the agglomeration of the by-product residue within the liquid, the mixing vessel preferably comprises an agitator 306, such as a rotatable impeller. The impeller can act to maintain a suspension of the by-product residue and also break up larger solids. In this way, a slurry may be produced.

Moreover, when the liquid is supplied to the mixing vessel 300 before the by-product residue, it may be agitated rather than static.

Once the slurry has been produced, and its temperature drops below a slurry temperature threshold, this may be discharged from the mixing vessel 300 via slurry outlet 350.

The discharge of the slurry from the mixing vessel may be assisted by a pressurised source of inert gas via a gas inlet (not shown) in the upper end of the mixing vessel 300. The inert gas is preferably nitrogen. Again, the predetermined wax content is preferably within a preferred range, since the wax content and liquid content of the slurry determine its adhesive properties and so how easily it is propelled by the inert gas.

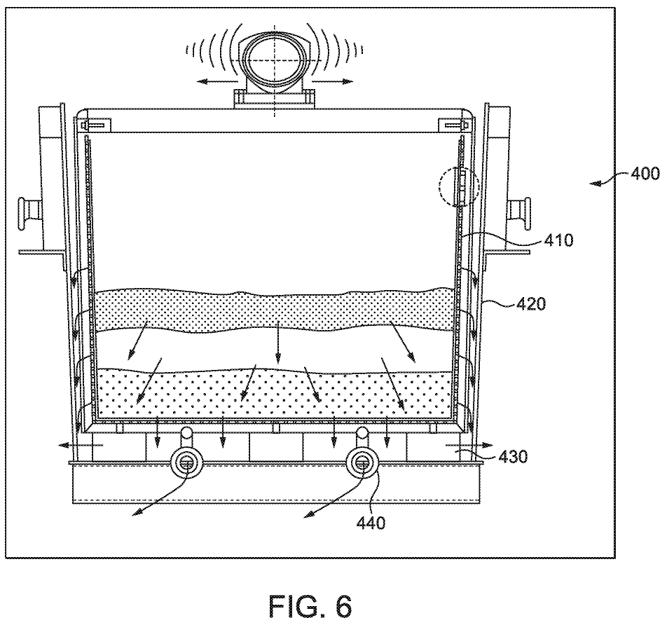

The slurry is discharged to a dewatering container 400, such as that shown in FIG. 6.

The dewatering container comprises a watertight container body 420, within which is supported a perforated container 410. The base and walls of the perforated container 410 are spaced from the container body 420 such that liquid can drain into the container body 410, while solids are retained within the perforated container 410. The slurry is delivered from the mixing vessel 300 into the perforated body 410.

One or more vibration elements 430 are provided for vibrating the perforated container 410 relative to the container body 420 to assist with the separation of liquid from the solids.

It is preferred that the walls and base of the perforated container comprise a perforated plate or mesh lined with a liquid permeable cloth or membrane.

The container body 420 comprises one or more filtrate outlets 440 for the draining of liquid.

1. A method of controlling a process for pyrolysis, comprising:
charging a reactor vessel with plastic material;
processing the plastics material by:
heating the reactor vessel to pyrolyse the plastics material;
driving an agitator within the reactor vessel to mix the material in the reactor vessel; and
receiving hydrocarbon vapour from the reactor vessel;
monitoring one or more parameter(s) consisting of:
the agitator load; and/or
a plurality of temperatures at a plurality of different heights within the reactor vessel; and/or
the temperature of vapour received from the reactor vessel; and
in response to the monitored parameter(s):
modifying the heating and/or driving; and/or
concluding the processing.

2. The method of claim 1, wherein the monitored parameter(s) are used to provide an indication of the wax content of the contents of the reactor vessel, and the method comprises concluding the processing in response to the monitored parameter(s) indicating the wax content is between 2% and 20% by mass, and preferably between 5% and 12% by mass.

3. The method of claim 1, wherein monitoring one or more parameter(s) comprises identifying a predetermined distribution of temperatures monitored by the plurality of temperature sensors.

4. The method of claim 1, wherein monitoring one or more parameter(s) comprises determining that a time sequence of predetermined distributions of temperatures has occurred.

5. The method of claim 1, wherein monitoring one or more parameter(s) comprises identifying a peak in agitator load, and in response to the identification of the peak: modifying the heating and/or driving; and/or concluding the processing.

6. The method of claim 1, wherein monitoring one or more parameter(s) comprises identifying a peak in the difference between temperatures measured by the plurality of temperature sensors, and in response to the identification of the peak: modifying the heating and/or driving; and/or concluding the processing.

7. The method of claim 1, wherein monitoring one or more parameter(s) comprises identifying when the vapour temperature has dropped below a vapour temperature threshold, and in response to this identification: modifying the heating and/or driving; and/or concluding the processing.

8. The method of claim 1, wherein monitoring one or more parameter(s) comprises:
identifying the occurrence of a peak in agitator load;
identifying the occurrence of a peak in the difference between temperatures measured by the plurality of temperature sensors; and
in response to the identification of both peaks:
modifying the heating and/or driving; and/or
concluding the processing.

9. The method of claim 1, wherein monitoring one or more parameter(s) comprises:
identifying the occurrence of a peak in agitator load;
identifying the occurrence of a peak in the difference between temperatures measured by the plurality of temperature sensors;
identifying when the vapour temperature has dropped below a vapour temperature threshold; and
in response to the identification of both peaks, and the vapour being below the vapour temperature threshold:
modifying the heating and/or driving; and/or
concluding the processing.

10. The method of claim 5, wherein the modifying step and/or the concluding step is implemented a predetermined period of time after the identification of the peak(s).

11. The method of claim 1, comprising heating the reactor vessel to a higher temperature in response to the monitored parameters.

12. The method of claim 1, comprising reducing the driving speed of the agitator in response to the monitoring of the agitator load.

13. The method of claim 1, wherein the process is concluded in response to the monitored parameter(s), and concluding the process comprises discharging the contents of the reactor vessel into liquid.

14. The method of claim 1, wherein concluding the process comprises discharging the contents of the reactor vessel into a mixing vessel holding liquid.

15-20. (canceled)

21. A method of controlling a process for pyrolysis, comprising:
charging a reactor vessel with plastic material;
heating the reactor vessel to pyrolyse the plastics material;
driving an agitator within the reactor vessel to mix the material in the reactor vessel;
receiving hydrocarbon vapour from the reactor vessel;
estimating the wax content of the reactor contents; and
discharging the contents of the reactor vessel when the estimated wax content is between 2% and 20% by mass, and preferably between 5% and 12% by mass.

22. A pyrolysis system comprising:
a reactor for the pyrolysis of plastics material including:
a reactor vessel having a supply inlet for receiving a feed of plastics material, a vapour outlet for egress of hydrocarbon vapour, and a char outlet for dispensing char;
an agitator for mixing material within the reactor vessel;
an actuator for driving the agitator; and
a heater for heating the contents of the reactor vessel,
a sensor system consisting of:
an actuator sensor for producing a signal indicative of an operating parameter of the actuator; and/or
a plurality of temperature sensors respectively located at a plurality of locations within the reactor vessel, each for producing a signal indicative of temperature; and/or
a vapour temperature sensor for monitoring the temperature of vapour downstream of the vapour outlet;
a controller in communication with the sensor system for controlling the reactor in one of a plurality of operating modes, wherein the operating modes include:
a pyrolysis mode in which the actuator drives the agitator at a first speed, and the heater produces a first amount of heat; and
a char discharging mode in which char is discharged through the char outlet,
wherein the controller is arranged to switch from the first of the operating modes to the second of the operating modes in response to signals from the sensor system.

23-27. (canceled)
